(19) United States
(12) Patent Application Publication
(10) Pub. No.: US 2014/0122105 A1
(43) Pub. Date: May 1, 2014

(54) Methods And Systems For Managing Healthcare Programs

(71) Applicant: Mercer (US) Inc., New York, NY (US)

(72) Inventors: Amy Laverock, New York, NY (US); Yi Li, Nutley, NJ (US)

(73) Assignee: Mercer (US) Inc., New York, NY (US)

(21) Appl. No.: 14/061,486

(22) Filed: Oct. 23, 2013

Related U.S. Application Data
(60) Provisional application No. 61/718,338, filed on Oct. 25, 2012.

(51) Int. Cl. G06F 19/00

(52) U.S. Cl. CPC G06F 19/345
USPC 705/2

(57) ABSTRACT

A method and system for the management of the planning and implementation of a target program, directed to a target entity, across multiple jurisdictions. In healthcare implementations, metrics associated with a particular health program for jurisdictions being considered, and for target groups within those jurisdictions, can be gathered and analyzed to generate a jurisdiction score for each jurisdiction. Recommendations regarding where to implement a health program and in what capacity can be made based on the generated jurisdiction scores.

This application claims benefit of priority to U.S. provisional application 61/718,338, filed Oct. 25, 2012. U.S. provisional application 61/718,338 is incorporated herein by reference in its entirety.

### FIELD OF THE INVENTION

The present invention relates to management of healthcare programs.

### BACKGROUND

Many companies provide health insurance for employees and the employees' family and dependents. As healthcare cost rises to record levels, it has become more difficult for companies to afford health insurance plans for the employees through commercial healthcare providers. As such, companies have been looking for ways to reduce health insurance costs. One way to reduce health insurance costs is to improve the overall health condition of the employees.

Efforts have been made over the years to assist companies in implementing health programs for improving employees' health conditions. For example, U.S. patent publication 2006/0085230 to Brill et al. titled “Methods and Systems for Healthcare Assessment”, filed May 4, 2005, discloses a system that collects employees' medical data, analyzes the data, and predicts conditions to which the employees are susceptible. The system disclosed in Brill also determines ways to eliminate or reduce healthcare costs associated with those predicted conditions by, for example, helping employees to change life-styles.

U.S. patent publication 2006/0277063 to Leonardi et al. titled “Preventive Healthcare Program with Low-Cost Prescription Drug Benefit Patient Enrollment System and Method”, filed Jun. 1, 2005, discusses a method and system of providing patients with beneficial preventive healthcare services in a manner that also provides them with access to necessary pharmaceuticals at a reduced cost.

U.S. patent publication 2008/0300916 to Parkinson et al. titled “Health Incentive Management for Groups”, filed Jan. 2, 2008, discloses a method that enables healthcare administrators to reconfigure health plans for a group of participants and generates impact information from the reconfiguration.

Other examples that are directed to cost-effective ways to manage healthcare include:

U.S. patent publication 2010/0262436 to Chen et al. titled “Medical Information System for Cost-Effective Management of Health Care”, filed Apr. 10, 2010, that discloses a system that uses medical information of patients to provide cost-effective management of healthcare;

U.S. patent publication 2011/0015960 to Martin et al. titled “Apparatus, Method, and Computer Program Product for Rewarding Healthy Behaviors and/or Encouraging Appropriate Purchases with a Reward Card”, filed May 18, 2010, that discloses a wellness program designed for encouraging and rewarding employees' healthy behaviors;

U.S. patent publication 2011/0046985 to Raheman titled “a Novel Method of Underwriting and Implementing Low Premium Health Insurance for Globalizing Healthcare”, filed Aug. 20, 2009, that discloses methods to underwrite health insurance programs that use low cost medical procedures overseas; and

International patent publication WO2004036480 to Chao et al. titled “Mass Customization for Management of Healthcare”, filed Oct. 17, 2003, discloses providing “customized” health plans to individuals based on demographics, income, drug history, medical history, lab values, etc.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

While the aforementioned references disclose different ways to reduce healthcare costs, such as implementing a health programs to improve employees' health conditions, none of them take into account the various characteristics of the employees (e.g., culture, location of residency, ethnicity, etc.) that could affect the effectiveness of those health programs. With respect to the Applicant's own work, for example, a stop smoking campaign may not be very effective for employees who live in an area in which cigarette smoking is popular. However, the same stop smoking program may be very effective in a region where other stop smoking programs are sponsored by different entities such as the government or a health group.

Thus, there is a need for a program management system that considers the effects of conditions and characteristics unique to each jurisdiction in assisting a program administer a manage health programs.

### SUMMARY OF THE INVENTION

The present inventive subject matter is drawn to systems, configurations, and methods for managing healthcare programs.

In an aspect of the inventive subject matter, the program management system ranks different jurisdictions with respect to some of the factors that drive the effectiveness (or likelihood of success) of a particular healthcare program (e.g., a “stop-smoking” campaign) in those jurisdictions.

The program management system can receive a query or request from a user to conduct an analysis on the applicability of a health program to various jurisdictions. The user can be a representative of a multi jurisdictional organization looking to compare various jurisdictions in which the organization operates. The request can include user-selected jurisdictions to consider and an identification of the health program. The request can also include a designated target entity of the program, such as a group of employees to which the health program would apply.

For the desired health program, the program management system can retrieve analysis templates, including a weighting scheme for metrics applicable to the health program. The system can then gather different metrics that represent different aspects of the jurisdictions with respect to the particular healthcare program. The metrics can include individual metric weights or metric adjustments according to jurisdictional characteristics. The metrics can also be related to the target entity that is the target of the health program.

The metrics can be automatically gathered by the system from various sources, and in embodiments, the metrics can be stored in a metrics database for use in an analysis. The metrics gathered and stored can be periodically updated by the system, to ensure the metrics and their values can be considered current. In embodiments, metrics and/or metric values used in an analysis can be manually modified by a user.

The weighting scheme can be a default weighting scheme that can be updated automatically according to evolving conditions associated with health programs, and/or according to the applicability of certain metrics. In embodiments, the default weighting scheme can be user-modified in at least some aspect.

The metrics can be grouped according to metric categories, and the weighting scheme for an analysis template can be applied according to metric categories.

The system can generate a score for each of the different jurisdictions based on these metrics. The generated score for a jurisdiction can generally indicates a predicted effectiveness (or likelihood of success), or a return of investment of implementing such healthcare program in a particular jurisdiction relative to other jurisdictions.

The program management system can present recommendations based on the generated jurisdiction scores. The recommendations can include a rank of the different jurisdictions based on the scores, including a visual display of scoring according to jurisdiction, statistical analysis and presentation of the scores according to each jurisdiction, and analysis regarding the recommendation including strategies and timing related to the implementation of the health program according to each jurisdiction.

It should be noted that in embodiments, the term “jurisdiction” is used euphemistically to mean a geo-political jurisdiction, or a group of geo-political jurisdictions. Examples of jurisdictions include a city, a county, a state, a territory, a country, a geographical region, etc. In embodiments, jurisdictions can also include different demographics, such as ethnicity, age group, gender, etc., such as within a geo-political jurisdiction or across multiple geo-political jurisdictions.

### BRIEF DESCRIPTION OF THE DRAWINGS

FIG. 1 provides an overview a system according to an embodiment of the inventive subject matter.

FIG. 2 is an overview of a sample process executed by the system.

FIG. 3 is an illustrative example of a part of a constructed program analysis template, as presented to a user.

FIG. 4 is an illustrative example of the remaining portion of the constructed program analysis template, as presented to a user.

FIG. 5 is an illustrative example of a table having user-changeable metric values.

FIG. 6 provides an example of metric scores in the raw score format, as presented to a user.

FIG. 7 provides an example of metric scores in the normalized score format, as presented to a user.

FIG. 8 is an illustrative example of recommendations presented in the heat map format.

FIG. 9 is an illustrative examples of recommendations presented in the 4D bubble chart format.

### DETAILED DESCRIPTION

Throughout the following discussion, numerous references will be made regarding servers, services, interfaces, engines, modules, clients, peers, portals, platforms, or other systems formed from, implemented by, or in the form of computing devices. It should be appreciated that the use of such terms is deemed to represent one or more computing devices having at least one processor (e.g., ASIC, FPGA, DSP, x86, ARM, ColdFire, GPU, multi-core processors, etc.) configured to execute software instructions stored on a computer readable tangible, non-transitory medium (e.g., hard drive, solid state drive, RAM, flash, ROM, etc.). For example, a server can include one or more computers operating as a web server, database server, or other type of computer server in a manner to fulfill described roles, responsibilities, or functions. One should further appreciate the disclosed computer-based algorithms, processes, methods, or other types of instruction sets can be embodied as a computer program product comprising a non-transitory, tangible computer readable media storing the instructions that cause a processor to execute the disclosed steps. The various servers, systems, databases, or interfaces can exchange data using standardized protocols or algorithms, possibly based on HTTP, HTTPS, AES, public-private key exchanges, web service APIs, known financial transaction protocols, or other electronic information exchanging methods. Data exchanges can be conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously. Within this document and in the context of networking the terms “coupled to” and “coupled with” are used to mean “communicatively coupled with” where two or more network enabled devices are configured to exchange data over a network possibly via one or more intermediary devices.

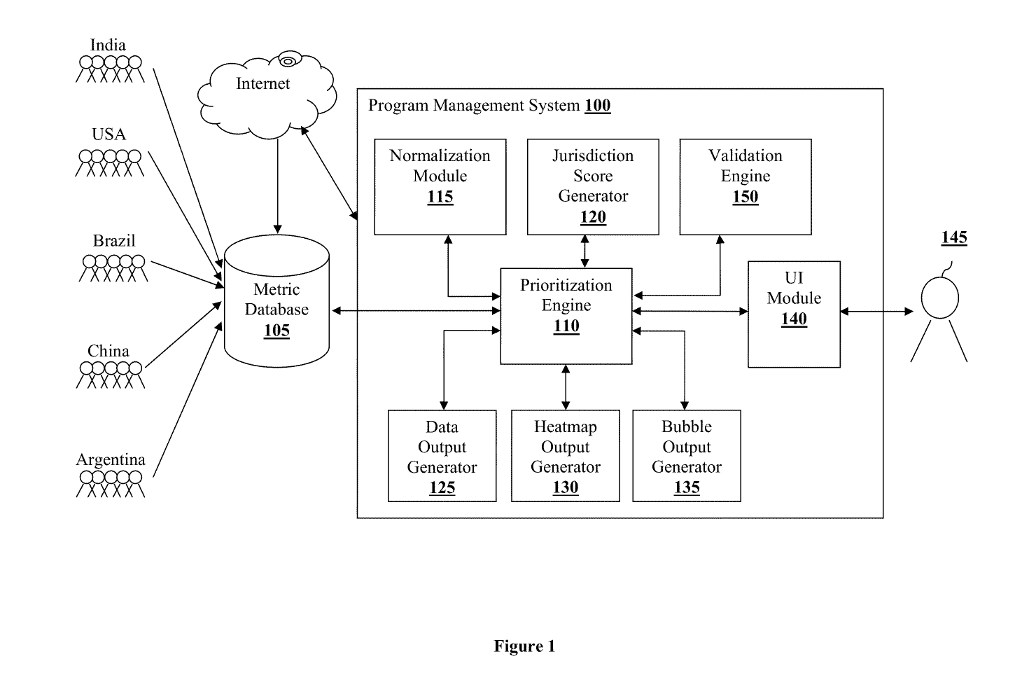

FIG. 1 illustrates an example of a program management system 100. As shown, the program management system 100 can include a prioritization engine 110, a normalization module 115, a jurisdiction score generator 120, one or more output generators 125-135, a validation engine 150, and a user interface (UI) module 140. In embodiments, one or more of the prioritization engine 110, the normalization module 115, the jurisdiction score generator 120, the output generators 125-135, the validation engine 150 and the UI module 140 can be implemented as computer-readable instructions stored on a non-transitory computer-readable storage medium (e.g., hard drive, ROM, DVD, optical, flash memory, solid-state drive, etc.) that are executable by at least one processing unit (e.g., a processor, a processing core) of one or more computing devices. In an embodiment, one or more of the normalization module 115, the jurisdiction score generator 120, the output generators 125-135, the validation engine 150 and the UI module 140 can be integral to the prioritization engine 110 (e.g., as applications, plugins, applets, instruction sets, etc., contained within the engine 110). In embodiments, one or more of the prioritization engine 110, the normalization module 115, the jurisdiction score generator 120, the output generators 125-135, the validation engine 150 and the UI module 140 can be implemented as dedicated computing hardware components (e.g., a specially programmed processor, such as via hard-coding, firmware; a dedicated circuit, etc.) communicatively coupled with one another as necessary to carry out functions and processes associated with the inventive subject matter. As illustrated in FIG. 1, the program management system 100 can be communicatively coupled with a metric database 105.

The metric database 105 can store a plurality of metrics that can be associated with one or more target programs, such as health programs, in various jurisdictions. For the purposes of the discussion of the inventive concept herein, the terms “target program” and “health program” are used interchangeably. However, a target program is not to be interpreted as being limited to only a health program. Other examples of target programs can include benefits programs, educational programs, employment programs, etc. As such, while the examples given here are directed to management of healthcare program, it is contemplated that the program management system 100 can also be used for managing different types of programs that are implemented across multiple jurisdictions.

Health programs can include organized efforts or campaigns aimed generally at improving the health of their target audiences. These campaigns can include campaigns such as those aimed at promoting health awareness (e.g., education about health; dispelling incorrect myths, traditions or beliefs about health; etc.), developing healthy habits and/or lifestyles, discouraging unhealthy habits and/or lifestyles, and incentivizing people to adopt changes, habits and/or lifestyles associated with healthy living. Examples of such health programs can include a stop-smoking program, a fitness challenge, health-related education programs, diet programs, medical maintenance programs, drug awareness, etc. In embodiments, these health programs can be initiated by an organization (e.g., a company) and target a specific group of people (e.g., employees of the company, a specific department of the company, a particular subset of employees of the company, etc.).

The metrics stored in metric database 105 can be considered factors and/or parameters that can affect or influence a decision of whether or not to implement a health program in a particular jurisdiction at a particular time, and, in embodiments, to what extent a health program should be implemented. In embodiments where a jurisdiction score is used as a measurement or basis for the decision, the metrics can be considered the factors can affect the generated jurisdiction score for a particular program or purpose, in a particular jurisdiction.

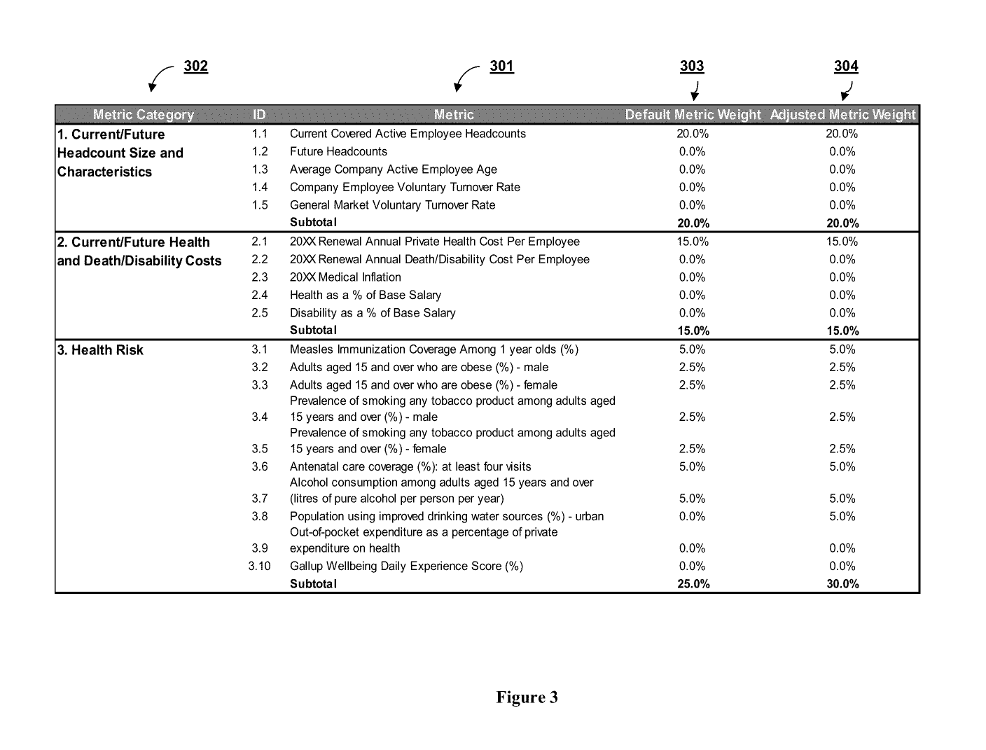

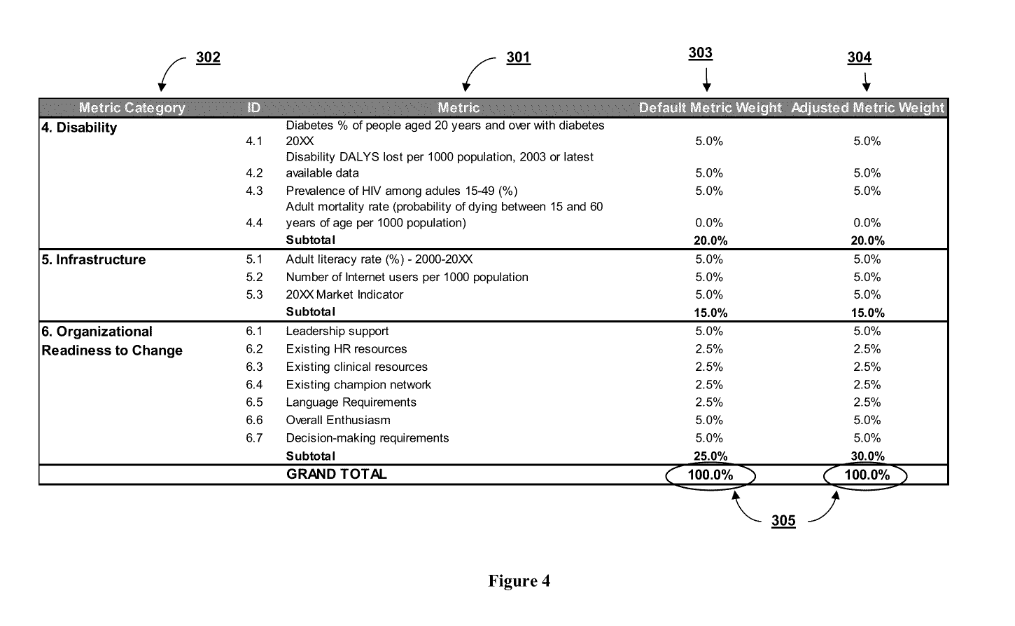

FIGS. 3 and 4 provide some illustrative examples of metrics 301. These examples include “current covered active employee headcounts”, “future headcount”, “average company active employee age”, “company employee voluntary turnover rate”, “general market voluntary turnover rate”, “renewal annual private health cost per employee” for a particular year, “renewal annual death/disability cost per employee” for a particular year, “medical inflation” for a particular year, “health as a % of base salary”, “disability as a % of base salary”, etc. Other examples of metrics can include “average number of sedentary hours a week”, “effectiveness of advertising media”, etc.

The metrics stored in metric database 105 and used by the system 100 can include numerical metrics or non-numerical metrics. Numerical metrics can be thought of as metrics that have a numerical value reflecting a measured or calculated amount, magnitude, percentage, etc. of the factor or characteristic represented by the metric. Non-numerical metrics can be thought of as the metrics whose values are non-numeric indicators (e.g., using words, phrases). Examples of non-numeric indicators can include categorical indicators of grouped ranges or values, indicators reflecting binary metric states (e.g., metrics whose value is “yes/no” to indicate whether the metric criteria exists, is met, etc.), conclusions to subjective evaluations, conclusions drawn in situations where raw data is not available, etc. One should appreciate that the metrics stored in metric database 105 are consider digital data constructs, metric objects for example. Each of such objects includes a metric value as discussed above and could also comprise other metadata describing the nature of the metric corresponding metrics. For example, a metric object can include attribute labels and corresponding attributes values (i.e., label-value pairs) representing a metric origin, a timestamp, an owner, a last modified time, a link to relevant metrics, jurisdictional applicability, or other information. In some embodiments, the metrics can be indexed according to their attributes, or according to other indexing schemes.

The metrics used by the system 100 can include metrics of various types. Examples of metric types include target-entity specific metrics, global metrics, regional metrics, public metrics, demographic metrics, cultural metrics, environmental metrics, economic metrics, social metrics, educational metrics, regulatory metrics, and jurisdictional metrics.

Metrics can be weighted to adjust their relative impact in a calculation, relative to other metrics. As such, metric values corresponding to a metric can be adjusted according to the weight. The weighting can be to account for factors associated with a metric having particular significance or importance, to account for a margin of error or a consistent deviation in a metric value, etc.

The metrics can include vendor weighted metrics, organizationally weighted metrics, entity weighted metrics, jurisdictionally weighted metrics, source-weighted metrics, statutory-weighted metrics, etc. For example, a vendor weighted metric can be a metric weighted by a particular vendor (e.g., health program provider, analysis provider, according to their analysis or gathering of the data etc.), or weighted because of a particular vendor (e.g., to account for particular practices of a vendor). In another example, a jurisdictionally weighted metric can be a metric weighted to account for unique or unusual circumstances particular only to that jurisdiction, so that the metric and metric values can be usable in the analysis while remaining an accurate representation of the metric. In yet another example, a source-weighted metric can include a weighted metric to account for a particular source, such as the reliability of the data (e.g., error correction), to account for bias or subjectivity in received data, etc.

Organizations having employees in multiple jurisdictions can be faced with making decisions regarding possible implementation of different health programs in different jurisdictions. These decisions can be influenced by and/or based on factors that might be particular to each jurisdiction. For example, a decision to implement a particular program can be based on the severity or prevalence of a particular health issue in each jurisdiction. For example, due to environmental conditions, cultural or societal norms, and/or the level of education in a particular jurisdiction, certain health issues may be more severe in that jurisdiction (e.g., higher rate of smokers, higher rate of heart diseases, higher rate of obesity, etc.), than in other jurisdictions. Consequently, employees of the organization in the jurisdiction can be considered to be more ‘at risk’ to those health issues than the employees in other jurisdictions. In embodiments, the metric database 105 can include metrics associated with factors particular to a jurisdiction. In the illustrated example, these metrics can include metrics reflecting the severity or prevalence of different health issues for the employees in different jurisdictions. In embodiments, the factors particular to each jurisdiction can be incorporated into existing metrics by weighting those metrics for each jurisdiction, whereby the weighting can be considered to adjust a metric to reflect the effect of the jurisdiction-specific factors. In the illustrated example, metrics associated with certain health issues can be weighted to reflect the severity or prevalence of those issues in a particular jurisdiction.

The metric database 105 can include metrics that can indicate a predicted or likely effectiveness of a particular health program in each jurisdiction. Decisions to implement different health programs in different jurisdictions can also be affected by a predicted effectiveness or likelihood of success of an implemented health program in a jurisdiction. Due to different cultures, norms, and employees' behaviors in different jurisdictions, a particular health program can be more effective in some jurisdictions than others. For example, a stop smoking campaign might not be very effective for employees who live in a jurisdiction in which cigarette smoking is common and popular. However, the same stop smoking program might be more effective in a region where smoking is regulated (e.g., laws on advertisement smoking products, laws on public smoking, smoking in restaurants, high taxes on tobacco products, etc.) or where other stop smoking programs sponsored by other entities, such as the government or a health group, are implemented at the same time. In another example, employees in one jurisdiction might be more receptive to particular types of advertising (or to advertising in general) than in other jurisdictions, which can reflect how likely the employees in different jurisdictions are to at least attempt to participate in or otherwise implement advertised health programs.

In embodiments, metrics associated with the effectiveness of a health program can be linked to metrics associated with health issues, including metrics reflecting the severity and/or pervasiveness of the health issue in a jurisdiction. The link can include rules such that if the metric associated with a health issue changes, the effectiveness metric changes according to the linking rules (e.g., algorithmically, proportionally, linearly, non-linearly, inversely, etc.). The link can include a weighting of an effectiveness metric, whose weighting factor can be associated with a health issue metric (and thus, change according to changes in the health issue metric). The linking of these metrics can be used to accurately represent situations where the causes, severity and/or prevalence of a health issue in a jurisdiction can, at least in part, directly influence a likelihood that programs targeting the issue will succeed. For example, one aspect of drug abuse is that a person may recognize the problem they have (e.g., by seeing the destructive effects of their abuse in their lives, such as due to the drugs being abused, etc.), and even have a great desire to stop the drug abuse, but be unable to do so because of an addiction. As such, if a jurisdiction has a serious drug abuse problem among certain employees, health programs targeting drug addiction may increase in effectiveness as the health issue gets more severe. Thus, the as the metric indicates the problem as increasingly more severe, linked metric(s) associated with the effectiveness of the program similarly increase. In another example, an increase in a severity of a health issue may result in a decreased predicted effectiveness of a health program targeting the issue. In a variation of the drug example above, it may be that drug use is pervasive among employees in a jurisdiction, but for the majority of employees, there might be little to no immediate negative effects of the drug use. As the drug use becomes more pervasive, it can become a societal norm for those employees. As such, the effectiveness of health programs targeting the drug use in this example can decrease as the drug use issue becomes more prevalent and severe because the employees (having gotten used to the drug as a social norm, and seeing little or no immediate negative effects) become less interested in quitting or more resistant to changing their habits.

Metrics can be organized according to categories that can have a collective effect on the calculation of a jurisdictional score. In embodiments, the metric categories can have a category score calculated as a function of the metrics contained within the category. The metric category scores can then be presented to illustrate a collective analysis of metrics within the category. In an embodiment, the metric category scores can be used to generate the jurisdictional score for a jurisdiction. For example, metric categories can have weights relative to other categories in the calculation of a jurisdictional score. In an embodiment, the jurisdictional score calculation can require certain metric categories, such as for standardization or normalization purposes across all jurisdictions. However, the actual metrics included within the metric categories for each jurisdiction can vary from jurisdiction to jurisdiction, and can be weighted or otherwise prioritized based on the importance, relevance, or applicability of the individual metrics to the jurisdiction. In embodiments, one or more of the metric categories can correspond to metric types.

FIGS. 3 and 4 provide some illustrative examples of metric categories that can be used to group metrics, such as “current/future headcount size and characteristics”, “current/future health and death/disability costs”, “health risk”, “disability”, “infrastructure”, and “organizational readiness to change”. As illustrated in FIGS. 3 and 4, each category contains the metrics corresponding to that category.

The factors that affect the implementation of a particular health program can change from time to time, as the norm or culture of a jurisdiction can shift or other health programs can be implemented and stopped at different times. Thus, the metrics can be automatically derived and/or changed according to various sources, such as digital market data, internal data, jurisdictional data, expert data, survey data, authoritative data, official data, organizational data, publicly accessible information (e.g., newspaper, articles, etc.), etc., via communication interfaces connected to networks such as the Internet, cellular networks, LAN, WAN, etc. It is also contemplated that the metric database 105 can include an interface that allows a program administrator or representatives from different jurisdictions to update the metrics from time to time.

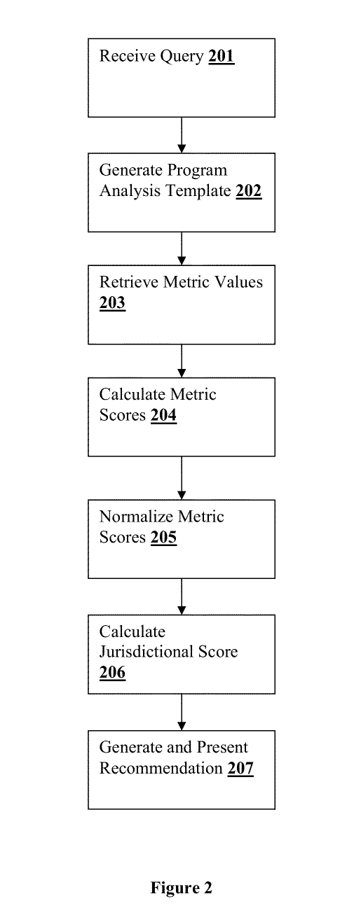

FIG. 2 provides an overview of a sample process executed by the system 100, according to an embodiment of the inventive subject matter.

As shown in FIG. 2, the system 100 can receive a request for a jurisdictional program analysis from a user 145 via the UI module 140 at step 201. The query can include input information required by the system 100 to perform the analysis, as well as optional information that can be used by the system 100 to enhance the results of the analysis. Examples of input information included in the query can include one or more of at least one jurisdiction (preferably, the query will include multiple jurisdictions for the purposes of comparison, a target program (e.g., health program), a target entity (e.g., all employees, groupings of employees by demographic, organizational department, etc.), a target issue (e.g., the health issue that the health program is directed to improve/solve), a program timeframe (e.g., desired time of implementation, desired length of program). In an embodiment, the UI module 140 can be configured to present selection options for constructing a query to the user 145 in a hierarchical fashion, where the user's inputs can be limited by prior selections. For example, if a user first selects a health program, the system 100 can then limit the choices of jurisdictions to those where it is possible to implement the selected health program. Conversely, if a user 145 first selects desired jurisdictions, a subsequent selection of a health program to implement presented to the user 145 can be limited to those health programs whose implementation is actually possible (e.g., limited to those where it is possible to implement in at least one jurisdiction, limited only to programs possible to implement in all selected jurisdictions, etc.).

At step 202, the prioritization engine 110 receives the query information and constructs a program analysis template based on the information contained in the query. The program analysis template can be considered the framework or structure of the analysis. To construct of the program analysis template, the prioritization engine 110 can retrieve metric categories and/or individual metrics associated with the entered health program from the metric database 105.

The metric database 105 can store weights assigned to metric categories and/or individual metrics, as well as metric weighting schemes for different health programs. As part of the construction of the program analysis template, the prioritization engine 110 can retrieve a metric weighting scheme corresponding to the health program. The metric weighting scheme can correspond to a default weighting scheme for that health program. The default weighting scheme can be a predefined weighting scheme, such as a historical weighting scheme for a particular health program previously used by the system, one derived via analysis of historical implementations of the health program, or a reference weighting scheme.

The constructed program analysis template can be presented to the user 145 via the UI module 140 for review prior to the analysis being performed, as illustrated in FIGS. 3 and 4. As depicted in FIGS. 3 and 4, the program analysis template includes the metrics 301 organized according metric categories 302, and including the default weighting scheme 303 for the particular health program. In embodiments, such as the one illustrated in FIGS. 3 and 4, the default metric weights can be adjusted, and an adjusted weighting scheme 304 is included in the program analysis template. In embodiments, the adjustments can be based on jurisdiction-specific metric conditions reflected by jurisdiction-specific weighting adjustments. Adjustments can also be based on linked relationships between metrics, where an adjustment to one metric causes a corresponding adjustment to another metric. In embodiments, the requesting user or other user can be allowed to adjust the weighting. For example, a weighting adjustment can be made by a user from a particular jurisdiction to account for jurisdiction-specific factors that only a local might be able to appreciate or perceive. In embodiments, the weights for both metrics and metric categories can be adjusted. In other embodiments, the weights for metrics can be adjusted, but the metric category weights remain fixed. Consequently, in these embodiments, the adjustments to the weights of individual metrics within a category can be limited to the amount permitted by a total category weight. As illustrated by the total weighting 305 in FIG. 4, the total weighting for a health program must always equal 100%. If an adjustment to the weights results in a total weighting of less than 100%, the prioritization engine 110 can perform an error-correction action. Error-correcting actions can include alerting the user of the error, reverting back to a previous non-error state, performing automatic error correction based on the nature of the adjustments (e.g., adjust metrics of ‘lower importance to compensate for the error), etc.

A project analysis template can be generated to include all of the metrics potentially applicable to a particular health program, even if historically some metrics have had marginal or no significance in the analysis. This allows for the adjustment of weights into metrics that can become relevant to the implementation of a health program over time. FIGS. 3 and 4 illustrate examples of some of these metrics 301, shown with a 0% default weight and/or a 0% adjusted weight.

At step 203, the prioritization engine 110 can retrieve metric values for the metrics included in the project analysis template. The metric values can be retrieved from various sources via networks such as the Internet, cellular connections, LAN, WAN, etc. The sources of the metric values can include internal databases (e.g., internal to the organization conducting the analysis, containing historical data from one or more of the jurisdictions in which it operates), market data sources, recognized scientific and/or medical authorities, jurisdictional sources (e.g., local government data), international organizations (e.g., the World Health Organization, the United Nations, Red Cross, UNICEF, etc.), news outlets, survey data, etc. In embodiments, metric values can also be provided by the user 145 via the UI module 140. User-provided values can serve to supplement or update other metric data values according to a user's knowledge extending beyond the metric values gathered through other means, or to add metric values that are missing or cannot be obtained elsewhere.

A metric value can be derived from the data of multiple sources, whereby the metric value can be a calculated value from the data of the sources. The metric value can be a calculated average, mean, or median. In embodiments, the metric value can be calculated using statistical algorithms that can incorporate factors such as the reliability or credibility of the various data sources, the elimination of statistically outlying or insignificant data, the elimination of data not considered to be current, etc., into the metric value calculation.

In embodiments, the step of gathering metric values can be performed upon the creation of each project analysis template, whereby all of the values are gathered from their corresponding sources at that time. In other embodiments, the metric database 105 can periodically gather one or more of the metric values for metrics stored in the metric database 105, updating the metric values for the metrics so that the metric data in database 105 can be considered current. In these embodiments, the prioritization engine 110 retrieves the metric values from the metric database 105 at step 203. In a variation of these embodiments, the prioritization engine 110 can receive the metric values together with the metrics gathered in step 202 (i.e., steps 202 and 203 are combined into a single step).

As discussed above, metrics can be in numerical form and non-numerical form. As such, the metric values retrieved by the prioritization engine 110 can correspondingly be numerical or non-numerical values, depending on the metric.

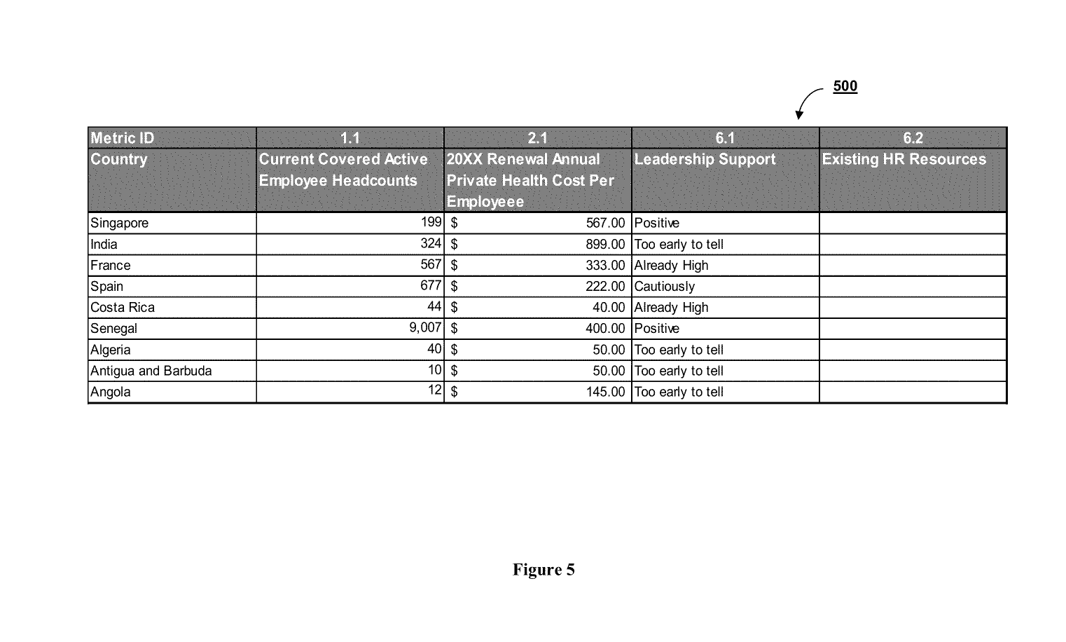

As discussed above, in embodiments a user 145 can be enabled to enter metric values via UI module 140. FIG. 5 illustrates an example of metrics having metric values, at least some of which can be entered or changed by user 145 (e.g., an administrator or representative from the organization). In this figure, the metrics and their values are illustrated in a table format 500. The rows of the table 500 represent different jurisdictions (e.g., Singapore, India, France, Spain, Costa Rica, Senegal, Algeria, Antigua and Barbuda, and Angola), while the columns of the table 500 represent different metrics (e.g., current active employee headcounts, health cost per employee, leadership support, and existing HR resources). Thus, for the jurisdiction of Singapore, the metric inputs indicate that it has a current employee headcounts of “199”, an average health cost per employee of “$567.00”, and a “positive” rating of leadership support. For the jurisdiction of India, the metric inputs indicate that it has a current employee headcounts of “324”, an average health cost per employee of “$899.00”, and a “too early to tell” rating of leadership support.

Table 500 includes a column for metric ID 6.2, corresponding to the “Existing HR resources” metric, the value fields of which are empty. Empty fields can be used to indicate to a user 145 that a user-provided metric value is required. Other indicators of necessary user input can be provided, such as a null value placeholder, or an indicator designed to alert the user 145 of a required user entry (e.g., highlighted table cells).

In embodiments, a user 145 can be allowed to modify some, but not all, of the metric field values in table 500. In these embodiments, the values that a user is allowed to modify can be made visually separate from non-modifiable values. This can be accomplished, for example, by highlighting either the modifiable or non-modifiable values (or both, using different highlights) via one or more of background and/or text colors, bolding, underlining, graying field entries out, or otherwise making the modifiable and non-modifiable value fields stand out from each other.

As illustrated, the metric inputs can be numerical in some embodiments, as in the case of the current active employee headcount, and can also be text-based in some embodiments, as in the case of the leadership support. In embodiments, these metric value inputs from the user can be stored in the metric database 105 as updates to existing metric values, or as new metric values for metrics previously lacking metric values. The user entry can consist of a user-entered value for some metrics. For other metrics (e.g., those having defined acceptable values, non-numerical values), the user entry can be in the form of a drop-down list or other listing that allows for the user to select a value from several pre-defined values.

In an embodiment, the table 500 can be used to modify the jurisdictions that are to be analyzed for the health program. Additional jurisdictions can be added, jurisdictions can be removed, or jurisdiction entries can be changed. As new jurisdictions are added (either via edits to existing jurisdictions or as additional jurisdictions to be considered), the metric values for those jurisdictions can be obtained by the prioritization engine 110 according to the steps described above.

At step 204, the metrics and metric values are received by the jurisdiction score generator 120, which can use them to generate a numerical score for each metric. For metrics that have numerical value, the numerical score can be identical as the metric value, or can be adjusted according to scoring algorithms. The adjustments can include jurisdiction-specific or metric-specific adjustments (e.g., such as the weighting for individual metrics discussed above). For metrics that have non-numerical values (e.g., text based values), the jurisdiction score generator 120 can apply rule sets to map the metrics values to corresponding numerical score values. The numerical score values corresponding to the non-numerical metric values can be stored in database 105. In an illustrative example, for the non-numeric metric values for the “leadership support” category shown in FIG. 5, the jurisdiction score generator 120 can map the metric value “already high” to a score of “5”, the metric value “positive” to a score of “4”, the metric value “too early to tell” to a score of “3”, and the metric value “cautiously” to a score of “2”.

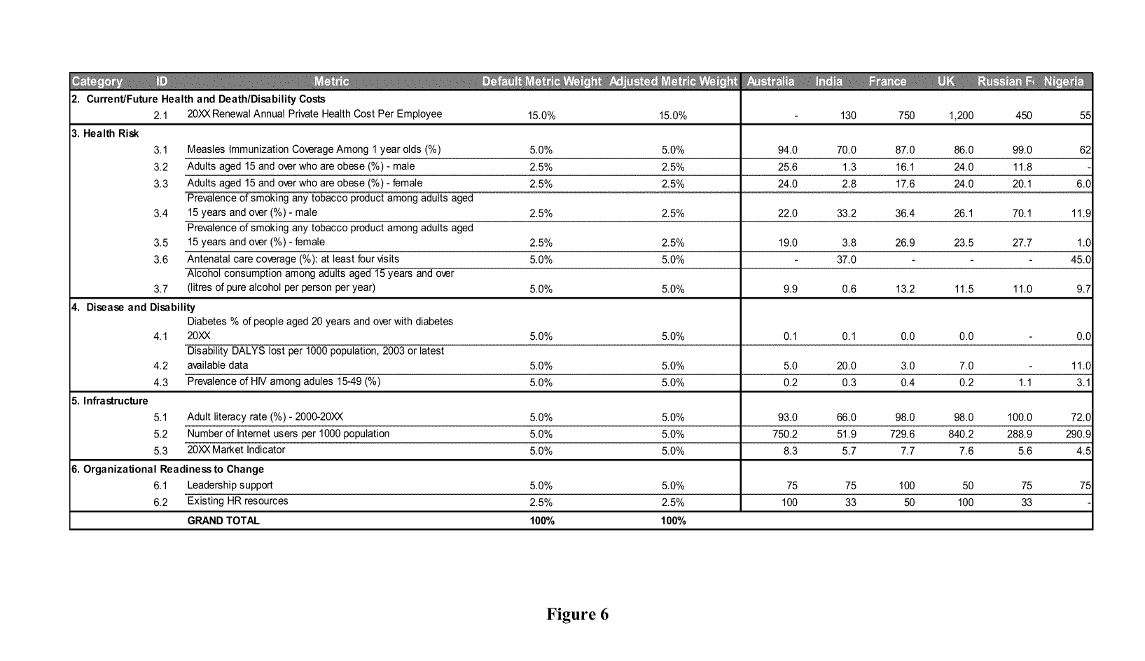

FIG. 6 is an illustrative example of the metric scores generated by the jurisdictions score generator 120 presented to the user 145 via the UI module 140. As shown in FIG. 6, the metric scores for each metric in each jurisdiction are presented to the user. The metric scores presented in FIG. 6 can be considered “raw” scores, in that they are generated scores based on the raw metric values prior to statistical manipulations or normalizations associated with the program analysis template. For metrics having individual weighting, the raw scores can reflect weighted metric values. For metrics having numerical metric values, the metric scores can be the metric values themselves.

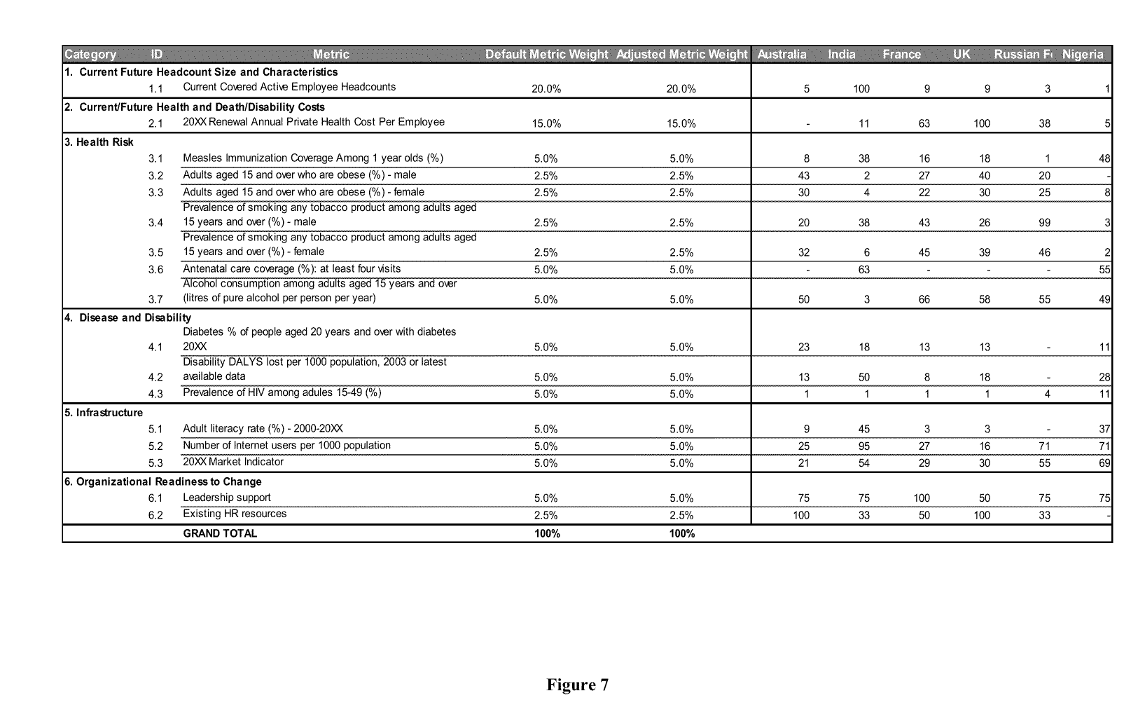

In embodiments, at step 205, the normalization module 115 can normalize the metric scores derived in step 204, and present those to the user 145. The presentation of the normalized metric scores is shown in FIG. 7.

The normalization module 115 can apply various normalization techniques to normalize the received metric scores. The technique(s) applied can depend on the nature of the metric and the metric score. Normalization techniques can include one or more of a normalization of ratings, normalization of scores, quantile normalization, and other statistical normalization techniques. In this example, the normalization module 115 has normalized the metric scores by adjusting the metric scores to a scale of 0 to 100, wherein the normalized scores includes normalization to retain the statistical significance of their original metric scores and/or metric values. In embodiments, the normalization performed in step 205 can be user-initiated, and as such, performed and displayed only upon request by the user 145.

At step 206, the jurisdiction score generator 120 can generate a jurisdiction score for each jurisdiction based on the metric scores for each metric of the jurisdiction. In embodiments, the jurisdiction score can provide an indication of a predicted effectiveness of implementing the particular health program in the corresponding jurisdiction. In other embodiments, the jurisdiction score can be representative of a return of investment (ROI) of implementing the particular health program in the corresponding jurisdiction. In yet some other embodiments, the jurisdiction score can indicate a preventative cost associated with the particular health program in the corresponding jurisdiction.

The jurisdiction score generator 120 can generate jurisdiction score as a function of the metric scores for the jurisdiction and their weights. As such, the jurisdiction score generator 120 applies the weights to each of the metric scores and calculates the jurisdiction score for each jurisdiction, by applying one or more scoring algorithms. If normalization has not yet been performed on the metric scores, the normalization module 115 can perform normalization prior to the generation of the jurisdiction scores. Alternatively, the scoring algorithms can include normalization and/or other statistical techniques to account for differences in metric score values, scales, frames of reference, statistical significance of the scores in their metrics, etc. Statistical algorithms that can be incorporated into the scoring algorithm include clustering algorithms, correlation and dependence algorithms, factor analysis algorithms, mean squared deviation algorithms, etc.

In embodiments, the scoring algorithm can be an aggregation algorithm, and the jurisdiction score can be an aggregated score of the weighted metric scores. Preferably, the aggregated score is an aggregation of weighted normalized metric scores.

In embodiments, metric category scores can be generated for metric categories, and presented along with, or instead of, the individual metric scores shown in FIGS. 6 and 7. The metric category scores can be calculated by the jurisdiction score generator 120 using the some or all of the same techniques and algorithms used in calculating the overall jurisdiction scores for each jurisdiction. The jurisdiction score generator 120 can also assign a weight to each metric score in a metric category according to their weight relative to the category, so that the metric category score properly reflects the relative importance of each metric within the category. In embodiments, the jurisdiction score generator can generate the jurisdiction scores for each jurisdiction according to the calculated metric category score instead of the individual metric scores.

At step 207, the prioritization engine 110 can generate a recommendation based on the calculated jurisdiction scores for the jurisdictions. The recommendations, including the metric scores calculated for the recommendations, can be stored in database 105 for future reference and to build evolving recommendations over time as health programs are implemented and executed to completion according to an organization's goals.

The program management system 100 can present a result of an analysis and/or a recommendation to the user through the UI module 140 based on the jurisdiction scores of the different jurisdictions.

The program management system 100 of some embodiments can present the recommendation in more than one format. For example, the program management system 100 of some embodiments can present the recommendation in a heat-map format, a four-dimensional (4D) bubble chart, a raw data format, and a normalized data format. In an embodiment, the program management system 100 can allow the user 145 to select the desired output format for the recommendation, via the UI module 140. Once the user selects one or more formats, the prioritization engine 110 can one or more output generators (125-135) to create the recommendation in the selected formats.

For example, for a raw data format, the recommendation can be a highlight of the jurisdiction(s) having the highest jurisdiction score(s). The recommendations can be presented to the user in the same format shown in FIG. 6, with the same raw date scores. The recommended jurisdictions can be highlighted via a box around the column corresponding to the “winning” jurisdiction, a color highlight, a background highlight, or other visual indicators. Additionally, the presentation can include an indicator of each jurisdictions calculated jurisdiction score. In embodiments, metric categories of particular importance can be highlighted accordingly (e.g., for highest scoring, biggest impact, etc.). Similarly, a recommendation presented in a normalized data format can be in the form of the table of FIG. 7, whereby the normalized scores are shown.

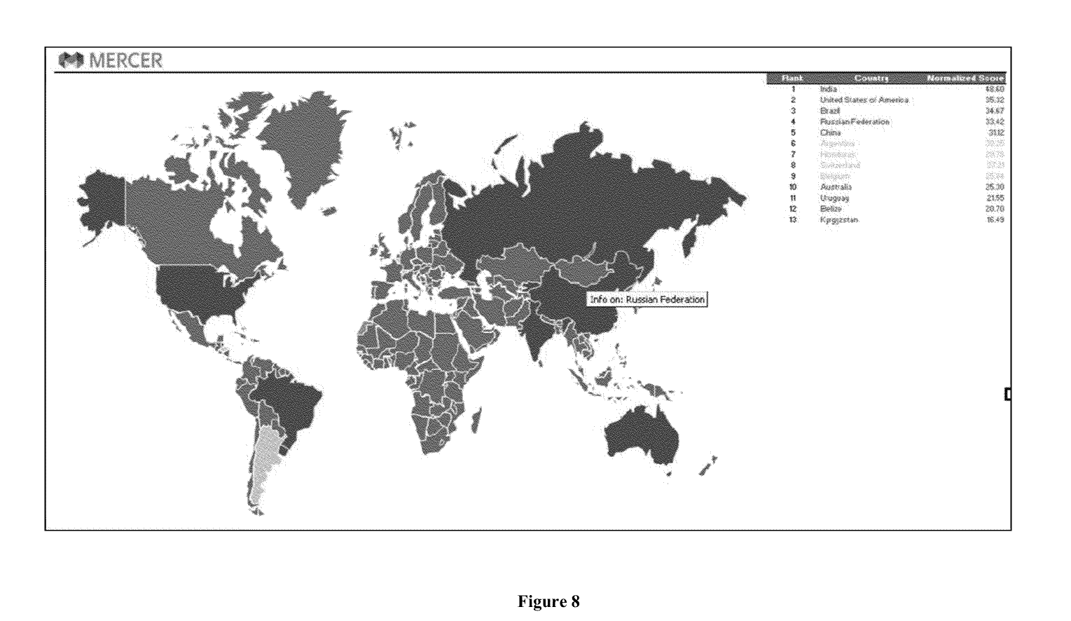

To construct a recommendation in the heat-map format, the prioritization engine 110 can send the normalized metric scores to the heatmap output generator 130 to generate a recommendation in the heat-map format. FIG. 8 illustrates an example of a recommendation in the heat-map format generated by the heatmap output generator 130. As shown, the recommendation is presented as a world map, with different jurisdictions (e.g., India, United States, Argentina, etc.) being filled with different colors. In this example, the different colors represent how well the jurisdiction scores for a health intervention. For example, jurisdictions having jurisdiction scores in the top third among all the jurisdictions (e.g., India, United States, Brazil, Russia, and China) can be represented by a red color, jurisdictions in the middle third of jurisdiction scores can be represented via a yellow color (e.g., Argentina, Honduras, Switzerland, and Belgium), and jurisdictions having jurisdiction scores in the bottom third can be represented via a green color (e.g., Australia, Uruguay, Belize, and Kyrgyzstan). The recommendations can also present the actual “normalized jurisdiction scores” of each jurisdiction on the top right. In embodiments, clicking on a country can bring up their raw data and/or normalized scores for each of the metrics (and/or metric categories), such as in the presentation formats of FIGS. 6 and 7.

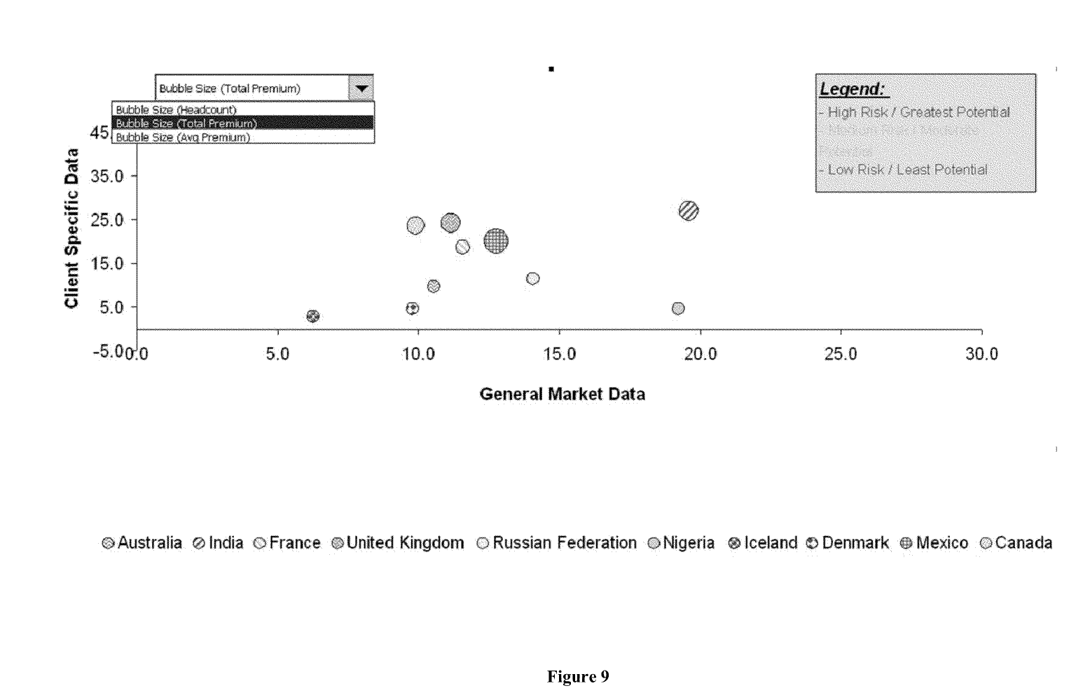

To construct a recommendation in the 4D bubble format, the prioritization engine 110 can send the normalized metric scores to the bubble output generator 135. FIG. 9 illustrates an example of a recommendation in the 4D bubble format. The four different dimensions can include (1) client specific data, (2) general market data, (3) jurisdictions, and (4) metric categories (sub-categories). As shown, the 4D bubble recommendation is presented as a graph with two axes. The horizontal axis (x-axis) can represent different normalized values based solely on the general market data and the vertical axis (y-axis) can represent different normalized values based solely on the client specific data. Each bubble in the graph can represent a different jurisdiction, and the location of the bubble indicates the normalized values (client specific data value and general market data value) for the corresponding jurisdiction. In addition to the jurisdiction scores, the user 145 can view the graphical representation of the different jurisdictions with respect to particular category or individual metric through the drop down menu 905. For example, the user 145 can select to view the graphical representation of only the headcount metric for each jurisdiction.

Recommendations can include additional information for particular metrics or metric categories, such as a predicted change in a metric. The predicted change can be a predicted result of the implementation of the health program on the metric itself. For example, metrics can include jurisdictional or regional metrics, which can include metrics associated with social or cultural effects that jurisdictions have on one another, such as due to geographic proximity, social or cultural commonalities among the populations of the jurisdictions, the prevalence of one jurisdiction's media in other jurisdictions, etc. As such, a change in social norms, customs or habits in a jurisdiction can have a “bleeding” effect into the social habits, norms or customs of another jurisdiction. A recommendation in this example can include predicted effects on the target jurisdiction as well as nearby jurisdictions, and can include information such as projected jurisdiction score increases in the nearby jurisdictions (e.g., in response to the nearby jurisdictions noticing the effect of the health program implemented in the target jurisdiction). The recommendation can further include information as to future implementations in the nearby jurisdictions, reflecting a predicted time in the future where the nearby jurisdictions will be optimally “ready” to receive the health program such that the program is most likely to achieve the goals of the organization.

As previously discussed, the factors that affect the metrics and metric values in each jurisdiction can change from time to time, as culture, norms, and human behavior change over time. Consequently, these changes to metrics and metric values can have an effect on previously calculated metric scores, jurisdictional scores, and recommendations. As such, the program management system 100 of some embodiments associates a time period for each metric score and jurisdiction score. In addition, the prioritization engine 110 of some embodiments can generate a recommendation that includes a trend of the jurisdiction score (or metric score) over a period of time.

In embodiments, the prioritization engine 110 can be configured to update metric scores, such as periodically, as triggered by events (e.g., an important event in a particular jurisdiction, a release of data or a report from an organization whose data is used in generating metric scores, etc.), or as directed by a user 145. In embodiments, the metric scores can be updated as metric values are updated in metric database 105. As the prioritization engine 110 updates metric scores, the prioritization engine 110 can recalculate or otherwise update generated jurisdiction scores. The prioritization engine 110 can further be configured update the recommendations being presented in real-time, to reflect updates in jurisdiction scores for particular jurisdictions. In embodiments, if updates to jurisdiction scores change the nature of a recommendation to a large enough degree (e.g., a new jurisdiction has the top jurisdiction score, a particular jurisdiction's change in score exceeds a threshold, a new jurisdiction score is indicative that either the new score or a previous score was inaccurate, etc.), the presentation of updated recommendations can include information related to the changes in the update, to alert the user 145 of a possible substantial change in a health program implementation recommendation.

It is contemplated that while the data gathered from the various sources, such as those discussed above, can be useful in providing recommendations regarding which jurisdiction is well suited for implementing a particular health program, users might wish to validate the recommendation to ensure accuracy and consistency. As such, in embodiments, the validation engine 150 can be used to validate the recommendation, and can present the validation results to the user 145 through the UI module 140.

Various techniques can be used to validate the recommendations. In some embodiments, the validation engine 150 can use historical data of each jurisdiction to validate the recommendations. In these embodiments, the validation engine 150 retrieves historical data of the different jurisdictions (e.g., from the Internet or from data that has been received and stored on the metric database 105), generating a probability distribution of the future trends based on the historical data, simulating the implementation of the particular healthcare program using data generated by the Monte Carlo method based on the probability distribution of the future trends, and validate the recommendations based on results from the simulation.

Instead of using historical data, the validation engine 150 of some embodiments can use expert opinions gathered using surveys or other means to validate the recommendations. In these embodiments, the validation engine 150 generates surveys, sends the surveys to known experts (or people randomly selected in the public), analyzes the survey results, and validates the recommendations based on the analysis.

It is contemplated that, in embodiments, the inventive subject matter can be a program management system comprising:

A project management metric database storing management metrics associated with at least one target program in at least one jurisdiction and related to at least one target entity, wherein the management metrics each include a metric value and a metric weight, and at least one metric weighting scheme corresponding to each of the at least one target program;

A UI module configured to receive user input information including at least one user-selected jurisdiction from the at least one jurisdiction, a user-selected target program from the at least one target program, and at least one user-selected target entity from the at least one target entity from a user and cause an output device to present output information to a user;

A prioritization engine communicatively coupled with the UI module and the metric database, the prioritization engine configured to receive the user input information from the UI module; receive, from the metric database, a metric weighting scheme and at least one selected metric based on the user input information; construct a program analysis template based on the received user input information, the received metric weighting scheme and the at least one metric; and generate at least one recommendation based on the at least one calculated jurisdiction score;

At least one output module communicatively coupled with the prioritization engine, configured to generate at least one recommendation output as output information in at least one recommendation output format, based on the generated at least one recommendation;

A jurisdictional score generator communicatively coupled with the prioritization engine, configured to receive the at least one selected metric and generate a metric score for each of the at least one selected metric based on the corresponding metric value of each of the at least one metric; and generate a jurisdiction score for each of the at least one jurisdiction based on the normalized metric score corresponding to the at least one selected metric;

A normalization module communicatively coupled to the prioritization engine and the jurisdictional score generator, and configured to receive the at least one metric score from the jurisdictional score generator, and generate a normalized metric score for each of the at least one metric based on the received metric score corresponding to each of the at least one metric; and

A validation module configured to validate the recommendation by constructing a simulation of the target program based on validation data, wherein the validation data includes at least one of historical jurisdiction data, expert data, and survey data; executing the constructed simulation; and analyzing the recommendation against the executed simulation.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A program management system comprising:
a program management metric database storing management metrics associated with a target program in at least one jurisdiction and related to a target entity; and
a prioritization engine communicatively coupled with the metric database and configured to:
derive a jurisdiction score as a function of the management metrics, where the jurisdiction score represents a prioritization of initiating the target program within the at least one jurisdiction;
generate a recommendation regarding initiating the target program based on the jurisdiction score; and
configure an output device to present the recommendation to a user.

2. The system of claim 1, further comprising an entity interface configured to receive updated management metrics.

3. The system of claim 2, wherein the prioritization engine is further configured to update the recommendation as a function of the updated management metrics.

4. The system of claim 3, wherein the prioritization engine is further configured to update the recommendations in real-time.

5. The system of claim 1, wherein the metrics comprise vendor weighed metrics.

6. The system of claim 1, wherein the metrics comprise entity weighted metrics

7. The system of claim 1, wherein the metrics comprises at least one of the following types of metrics: target-entity specific metrics, global metrics, public metrics, demographic metrics, cultural metrics, and jurisdiction metrics.

8. The system of claim 1, wherein the metrics comprise non-numerical metrics.

9. The system of claim 1, wherein the jurisdiction comprises a geo-political jurisdiction.

10. The system of claim 1, wherein the jurisdiction comprises a demographic.

11. The system of claim 1, wherein the target program comprises a healthcare management program.

12. The system of claim 1, wherein the recommendation comprises a plurality of jurisdiction scores each corresponding to a different jurisdiction.

13. The system of claim 12, wherein the jurisdictions are ranked according to their respective jurisdiction scores.

14. The system of claim 1, wherein the recommendation comprises a heat map.

15. The system of claim 1, wherein the recommendation comprises a chart.

16. The system of claim 1, wherein the recommendation comprises raw data.

17. The system of claim 1, wherein the recommendation comprises normalized data.

18. The system of claim 17, wherein the jurisdiction score comprises at normalized score.

19. The system of claim 1, wherein the jurisdiction score reflects a return on investment (ROI) of the target program in the at least one jurisdiction.

20. The system of claim 1, wherein the jurisdiction score reflects a preventative cost associated with the target program in the at least one jurisdiction.

21. The system of claim 1, wherein the recommendation comprises a time-dependent jurisdiction score derived from the jurisdiction score.

22. The system of claim 21, wherein the recommendation comprises a trend of the time-dependent jurisdiction score.

23. The system of claim 1, wherein the recommendation comprise a validation score associated with the at least one jurisdiction score.

24. The system of claim 1, wherein the recommendation indicates the target program should be initiated.

25. The system of claim 1, wherein the recommendation indicates the target program should not be initiated.
